(19) United States
(12) Patent Application Publication
(10) Pub. No.: US 2016/0216237 A1
(43) Pub. Date: Jul. 28, 2016

(54) Ultrasonic Sensor Having A Deflecting Element

(71) Applicant: CONTINENTAL AUTOMOTIVE GMBH, Hannover (DE)

(72) Inventor: Manfred Roth, Grosshabersdorf (DE)

(73) Assignee: Continental Automotive GmbH, Hannover (DE)

(21) Appl. No.: 14/916,083

(22) PCT Filed: Sep. 8, 2014
(86) PCT No.: PCT/EP2014/069076

§ 371 Date: Mar. 2, 2016

(30) Foreign Application Priority Data
Sep. 9, 2013 (DE) 10 2013 218 001.2

(51) Int. Cl. G01N 29/024; G01F 23/296

(52) U.S. Cl. CPC G01N 29/024; G01F 23/2962; G01N 2291/011

(57) ABSTRACT

An ultrasonic sensor is disclosed for performing a propagation-time measurement in a liquid. The ultrasonic sensor includes an ultrasound transmitter and a deflecting element made of plastic, into which deflecting element the ultrasound pulses emitted by the ultrasound transmitter are conducted, which ultrasound pulses are deflected on a boundary surface within the deflecting element by reflection. A hermetically sealed air bag is arranged inside the deflecting element. A wall of the air bag forms the plastic/air boundary surface for reflecting the ultrasound pulses. The ultrasonic sensor may provide improved functional capability of the deflecting element over a long time period, while being economical to produce.

### CROSS-REFERENCE TO RELATED APPLICATIONS

This application is a U.S. National Stage Application of International Application No. PCT/EP2014/069076 filed Sep. 8, 2014, which designates the United States of America, and claims priority to DE Application No. 10 2013 218 001.2 filed Sep. 9, 2013, the contents of which are hereby incorporated by reference in their entirety.

### TECHNICAL FIELD

The present invention relates to an ultrasound sensor for performing a propagation time measurement in a liquid, having an ultrasound transmitter and having a diverting element composed of plastic, into which diverting element the ultrasound pulses emitted by the ultrasound transmitter are conducted, said ultrasound pulses being diverted by reflection on a boundary surface within the diverting element.

### BACKGROUND

An ultrasound sensor of said type is known. It serves for the measurement of the concentration and of the fill level of a urea solution in a tank which is carried on-board in motor vehicles for the purposes of supplying the urea solution to the exhaust gas of the motor vehicle and thereby reducing the NO_{X} content of the exhaust gas. The functional principle of said sensor is based on the propagation time measurement of reflected ultrasound pulses, wherein the fill level of the urea solution and the concentration thereof are determined from the measured propagation times.

In the case of the known sensor, the ultrasound transmitter is situated below the base wall of the liquid tank. The emitted ultrasound pulses pass through the base wall into a diverting element, in which the pulses are diverted through 90° by reflection on a boundary surface. Here, the diversion is effected by a metallic mirror element arranged on the diverting element, which is otherwise composed of plastic. In this known embodiment, therefore, the boundary surface on which the ultrasound pulses are reflected is formed by the transition surface between the plastics element and the metal element, wherein the latter may be composed of high-grade steel. Here, owing to the large acoustic impedance difference between plastic and steel, a high degree of reflection of the ultrasound is achieved.

The plastic may comprise HDPE (high-density polyethylene). Owing to the mechanical characteristics of said material and the large difference in thermal expansion behavior between said material and steel, however, it is ultimately not possible to realize a positively locking connection between the plastic and the steel element over the course of the service life and thermal aging of the sensor. Rather, the reflection characteristics of the assembly deteriorate over the course of time, which leads to a deterioration of the ultrasound sensor signals. This in turn leads to a loss of function of the sensor with regard to concentration and/or fill level measurement.

### SUMMARY

One embodiment provides an ultrasound sensor for performing a propagation time measurement in a liquid, having an ultrasound transmitter and having a diverting element composed of plastic, into which diverting element the ultrasound pulses emitted by the ultrasound transmitter are conducted, said ultrasound pulses being diverted by reflection on a boundary surface within the diverting element, characterized in that, in the interior of the diverting element, there is arranged a hermetically sealed air pocket, the wall of which forms the plastics/air boundary surface for the reflection of the ultrasound pulses.

In a further embodiment, the plastics/air boundary surface has an inclined attitude for the diversion of the ultrasound pulses from a vertical sound path into a horizontal sound path.

In a further embodiment, the air pocket is of rectangular form in cross section, wherein the plastics/air boundary surface is formed by a long side of the rectangle.

In a further embodiment, the diverting element is arranged on the base of a liquid tank.

In a further embodiment, the ultrasound transmitter is arranged on the underside of the base wall of a liquid tank, and the diverting element is arranged opposite, on the top side of the base wall of the liquid tank.

In a further embodiment, the air pocket is produced by injection molding and subsequent welding of the air pocket.

In a further embodiment, the air pocket is produced by the mounting of an additional plastics part on the diverting element.

In a further embodiment, the rear wall, which does not participate in the reflection of the ultrasound, of the air pocket is in the form of a movable diaphragm.

### BRIEF DESCRIPTION OF THE DRAWINGS

Example embodiments of the invention are discussed in detail below with reference to the drawings, in which:

FIG. 1 is a schematic sectional illustration of a diverting element of an ultrasound sensor according to the prior art;

FIG. 2 is a schematic sectional illustration of a diverting element of an ultrasound sensor according to one embodiment of the invention; and

FIG. 3 is a schematic sectional illustration of a further embodiment of a diverting element of an ultrasound sensor according to the invention.

### DETAILED DESCRIPTION

Embodiment of the invention provide an ultrasound sensor that is inexpensive to produce, while providing particularly good functionality of the diverting element over a long period of time.

Some embodiments provide an ultrasound sensor having a diverting element and a hermetically sealed air pocket in an interior of the diverting element, the wall of which air pocket forms the plastics/air boundary surface for the reflection of the ultrasound pulses.

Therefore, an abrupt impedance change between plastic and air is provided in the interior of the diverting element, by way of a hermetically sealed air pocket or a correspondingly hermetically sealed air enclosure in the plastics material. Here, the air pocket may be geometrically designed to perform the desired function as a reflector. Said air pocket must furthermore be hermetically sealed with respect to the medium for measurement, for example water, urea solution, or further operating substances. A corresponding ingress of said substances into the air pocket will lead to a loss of function of the diverting element and thus of the sensor.

The plastic diverting element may be designed such that pressure fluctuations in the air pocket or in the air enclosure owing to temperature changes do not lead to fracture of the element or to intolerable changes in shape of the air pocket.

The plastics/air boundary surface may have an inclined attitude configured to divert the ultrasound pulses from a vertical sound path into a horizontal sound path. Here, the diverting element serves for example for generating a horizontal sound path which is used for propagation time measurement in a liquid situated in a container, wherein the ultrasound pulses, on their horizontal sound path, strike reflectors and are reflected back from there, via the diverting element, to the ultrasound transmitter, which also serves as receiver.

The air pocket provided may have a rectangular cross section, wherein the plastics/air boundary surface may be formed by a long side of the rectangle. The ultrasound pulses may therefore be reflected on said boundary surface.

As already mentioned, the diverting element may be arranged on the base of a liquid tank. Here, the ultrasound transmitter may be situated on the underside of the base wall of a liquid tank of said type, and that the diverting element is arranged opposite, on the top side of the base wall of said liquid tank.

An ultrasound sensor of said type may also be used both for measurement of the concentration of a liquid and for measurement of the fill level of said liquid. Here, it is for example the case that ultrasound pulses from the ultrasound transmitter arranged on the underside of the base wall of the tank are transferred, by way of the diverting element, into a horizontal sound path, wherein a part of the pulses strikes reflectors which reflect said part of the pulses back to the ultrasound transmitter. Another part of the pulses of the horizontal sound path strikes a further diverting element here, and is diverted by said diverting element upward to the surface of the liquid and reflected back from there again. Said latter diverting element may also have a hermetically sealed air pocket, the wall of which forms the plastics/air boundary surface for the reflection of the ultrasound pulses.

The mode of operation of the diverting elements corresponds with regard to the ultrasound pulses reflected back.

In one embodiment, the air pocket is produced by injection molding and subsequent welding of the air pocket. In another embodiment, the air pocket is produced by the mounting of an additional plastics part on the diverting element, wherein said mounting may be performed by way of welding.

It is accordingly possible, e.g., via the plastics injection molding process, for the air pockets to be introduced into the molded part by way of movable slides. The opening of the pocket is thereafter welded in air-tight fashion. As mentioned, the air pockets may also be generated by virtue of plastics elements being welded onto the diverting element. Such method may provide better shaping of the air pocket, for example through the avoidance of sink marks on the plastic as a result of shrinkage.

The rear wall, which does not participate in the reflection of the ultrasound, of the air pocket may comprise a movable diaphragm. In this way, pressure fluctuations that arise in the air pocket as a result of temperature changes, for example, can be accommodated.

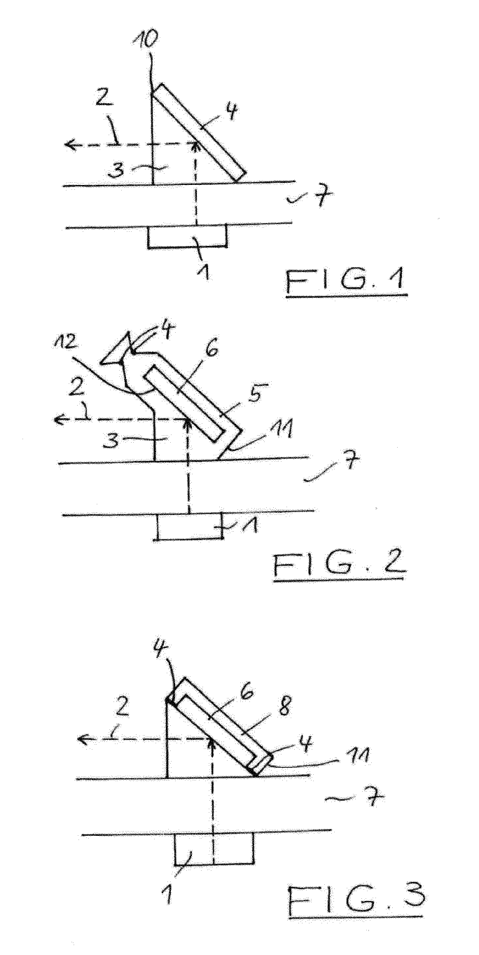

Of an ultrasound sensor according to the prior art, FIG. 1 illustrates only the ultrasound transmitter 1, which also serves as receiver, and a sound diverting element 10. The sound pulses emitted by the ultrasound transmitter 1 penetrate through the base wall 7 of a liquid tank which contains, for example, a urea solution. The purpose of the ultrasound sensor is to measure the concentration of the urea solution by way of an ultrasound propagation time measurement. Here, the sound pulses 2 that are diverted within the diverting element 10 pass, in a horizontally running sound path, to reflectors, are reflected back from there, and pass back again via the diverting element 10 to the sound transmitter 1, which also operates as receiver.

The diverting element 10 according to the prior art illustrated here has a plastics molded part 3 which is of approximately triangular cross section and which, on its oblique side, bears a metallic mirror element 4 composed of high-grade steel. The disadvantages of such an embodiment have been discussed above.

In the embodiment of a diverting element 11 according to the invention, as illustrated in FIG. 2, an air pocket 6 is integrated into a plastics molded part 3. The opening of said air pocket 6 is welded in air-tight fashion, as indicated by the weld seams 4. The rear wall 5, formed by the plastics molded part 3, of the air pocket 6 is in this case formed, in effect, as a movable diaphragm, in order to be able to compensate pressure fluctuations within the air pocket 6.

In this embodiment, the ultrasound pulses emitted by the sound transmitter 1 pass to the plastics/air boundary surface 12, which is formed by a long wall of the rectangular air pocket 6. A diversion of the pulses 2 by reflection takes place at said boundary surface 12. Since it is the case here that there is no plastics/metal connecting surface as in the prior art, no change in the diversion or reflection behavior of said surface is to be expected as a result of aging.

FIG. 3 shows a further embodiment of the invention. Here, the diverting element 11 is composed of a plastics molded part 3, to which a further, mounted plastics molded part 8 is welded, as indicated by the weld seams 4. The further molded part has a cavity which forms a corresponding air pocket 6. The desired diversion or reflection of the sound pulses 2 emitted by the sound transmitter 1 takes place at the boundary surface 12 between the air pocket 6 and the molded part 3.

What is claimed is:

1. An ultrasound sensor for performing a propagation time measurement in a liquid, comprising:
an ultrasound transmitter configured to emit ultrasound pulses,
a plastic diverting element arranged to receive the ultrasound pulses emitted by the ultrasound transmitter, and
a hermetically sealed air pocket within an interior of the diverting element, the hermetically sealed air pocket having a wall that defines a plastics/air boundary surface that reflects the received ultrasound pulses.

2. The ultrasound sensor of claim 1, wherein the plastics/air boundary surface has an inclined attitude configured to divert the ultrasound pulses from a vertical sound path into a horizontal sound path.

3. The ultrasound sensor of claim 1, wherein the air pocket has a rectangular cross section, and wherein the plastics/air boundary surface is formed by a long side of the rectangular cross section.

4. The ultrasound sensor of claim 1, wherein the diverting element is arranged on a base of a liquid tank.

5. The ultrasound sensor of claim 1, wherein the ultrasound transmitter is arranged on an underside of a base of a liquid tank, and the diverting element is arranged on a top side of the base of the liquid tank.

6. The ultrasound sensor of claim 1, wherein the air pocket is produced by injection molding and subsequent welding of the air pocket.

7. The ultrasound sensor of claim 1, wherein the air pocket is produced by mounting additional plastic part on the diverting element.

8. The ultrasound sensor of claim 1, wherein the diverting element has a rear wall located on an opposite side of the air pocket from the plastic/air boundary surface, wherein the real wall defines a movable diaphragm.

9. A liquid tank assembly, comprising:
a liquid tank; and
an ultrasound sensor coupled to the liquid tank, the ultrasound sensor comprising:
an ultrasound transmitter configured to emit ultrasound pulses,
a plastic diverting element arranged to receive the ultrasound pulses emitted by the ultrasound transmitter, and
a hermetically sealed air pocket within an interior of the diverting element, the hermetically sealed air pocket having a wall that defines a plastic/air boundary surface that reflects the received ultrasound pulses.

10. The liquid tank assembly of claim 9, wherein the plastics/air boundary surface has an inclined attitude configured to divert the ultrasound pulses from a vertical sound path into a horizontal sound path.

11. The liquid tank assembly of claim 9, wherein the air pocket has a rectangular cross section, and wherein the plastics/air boundary surface is formed by a long side of the rectangular cross section.

12. The liquid tank assembly of claim 9, wherein the diverting element is arranged on a wall of the liquid tank.

13. The liquid tank assembly of claim 9, wherein the ultrasound transmitter is arranged on a one side of a wall of the liquid tank, and the diverting element is arranged on an opposite side of the wall of the liquid tank.

14. The liquid tank assembly of claim 9, wherein the air pocket is produced by injection molding and subsequent welding of the air pocket.

15. The liquid tank assembly of claim 9, wherein the air pocket is produced by mounting an additional plastic part on the diverting element.

16. The liquid tank assembly of claim 9, wherein the diverting element has a rear wall located on an opposite side of the air pocket from the plastic/air boundary surface, wherein the real wall defines a movable diaphragm.
